(19) United States
(12) Patent Application Publication
(10) Pub. No.: US 2010/0089494 A1
(43) Pub. Date: Apr. 15, 2010

(54) Container coupler

(76) Inventor: Pam Brady, Mesa, AZ (US)

Correspondence Address: Alan Carlson, 6202 Lynn Lane, Lago Vista, TX, 78645, US

(21) Appl. No.: 12/287,942

(22) Filed: Oct. 14, 2008

(51) Int. Cl. B65B 1/04; B67C 3/00

(52) U.S. Cl. 141/364; 141/368; 141/363; 141/2

(57) ABSTRACT

A container coupler is disclosed that can be adapted to mechanically engage two containers. The container coupler can include a member that has an arcuate inner surface to engage a neck of the first container and the neck of a second container. The coupler can have a latch and a keeper wherein the keeper is configured to engage the latch and fastening the latch can reduce the inner diameter of the container coupler and tighten the coupler around the neck of each container. In some embodiments the coupler is manufactured in a “C” shape with a gap and in other embodiments the coupler can be two “C” shaped pieces that are hinged together such that a gap between the “C” shaped pieces can be reduced as the coupler is tightened on the necks of the bottles. Inserts can be placed in the coupler to accommodate bottles with different sized necks or mouths. Other embodiments are also disclosed.

### BACKGROUND

The present disclosure generally relates to conveying materials from one container to another container. More particularly, the disclosure relates to an apparatus for engaging the neck portion of two containers and mechanically securing the first container to the second container while the contents of one container are transferred to the other container.

Different types of bottle couplers for draining the contents of one container into another container have apparently been in use for over fifty years. However, these bottle couplers have many shortcomings. First, traditional bottle couplers do not hold the necks of the containers or bottles very tight and if the container on the top (to be drained) is relatively full, the connected containers will have a high center of gravity. This makes the coupled bottles unstable as they can easily tip over. Most traditional couplers do not grip the containers very tight and if the coupled containers tip over, the containers will often separate spilling the contents of the containers all over, usually on the floor in hard to clean areas. Many have tried to solve this problem for decades.

Many have tried to mitigate this often messy procedure by inventing some sort of container stand or bottle stand with the bottle coupler to keep the containers from falling over. As can be seen below by the number of issued patents for draining one container to another, many coupling features have been taught. Restaurant materials, such as catsup, mayonnaise and dressings become more expensive and throwing away these materials or throwing away containers that are not empty results in considerable losses for restaurateurs.

U.S. Pat. No. 6,745,802 teaches a bottle drainage coupler unit having upper and a lower coupler pairs to support bottles with viscous fluid such as catsup for stable, effective mouth to mouth drainage. One bottle is supported in a slanted position apparently to let air out of the lower bottle as the catsup is transferred.

U.S. Pat. No. 6,085,806 discloses an oil drain kit for collecting used motor oil comprising an oil drain collection pan, having a bottom wall raised at the center and sloping to its marginal extremity where it is joined with a side wall having a radial flange at the top of the wall and which extends circumferentially thereabout with a downwardly extending edge portion. The bottom wall is provided at its extremity adjacent to its junction with the side wall having at least three discharge openings, each with a funnel spout extending downwardly there from. The spouts are adapted to receive the necks of empty oil containers which connect therewith and serve as supporting legs for the drain collection pan.

U.S. Pat. No. 5,964,260 discloses a connector device designed to connect two tubes or containers so as to allow the transfer of fluids from one tube or container to the other. The connector device includes a tubular member made from an elastic material, with the tubular member having an inner wall that includes longitudinal slits. The tubular member can be made from one individual tube or a pair of joined, flanged tubes. The flanged tubular members are joined at the flange positions and held together by a collar member.

U.S. Pat. No. 5,884,678 discloses a connector device designed to connect two tubes or containers so as to allow the transfer of fluids from one tube or container to another. The connector device includes a tubular member made from an elastic material, with the tubular member having an inner wall that includes longitudinal slits. The tubular member can be made from one individual tube or a pair of joined, flanged tubes. The flanged tubular members are joined at the flange positions and held together by a collar member. Furthermore, a plurality of individual tubular members can be placed in a rectangular frame member so that the tubular members are perpendicular and integral to the frame member.

U.S. Pat. No. 5,740,654 discloses a packaging assembly intended for the extemporaneous preparation of suspensions or solutions of a solid active product in a liquid product, the active product having been freeze dried and being contained in a flask A and the liquid product being contained in a flask B closed by a dropper, a connection member enabling to put in communication the two flasks for the purpose, in a first step, to cause the liquid product to pass from flask B into flask A containing the solid product, then in a second step, to reverse the assembly and aspirate into flask B, the suspension or solution thus formed.

U.S. Pat. No. 5,642,763 discloses a liquid draining device including a body having a central passageway extending therethrough, an interior funnel formed at the top end of the central passageway near the top end of the body and an interior drip guide formed at the bottom end of the central passageway near the bottom end of the body. The funnel is for receiving any remaining liquid from a first narrow neck container disposed in an inverted relation thereover. The drip guide is for discharging any liquid draining down from the funnel through the central passageway into a second narrow neck container disposed in an upright relation thereunder.

U.S. Pat. No. 5,490,545 discloses a vortex connector system with a connector body with a projection therein to selectively abut one of a plurality of removable inserts. The removable inserts have holes with different sizes, shapes, patterns, depths and numbers, in order to allow observation of how such variations affect the vortex effect and/or flow rate of fluid between plastic bottles connected by the connector body.

U.S. Pat. No. 5,285,824 discloses an oil drainage catch pan having an open top for receiving used engine oil drained therein, has a reservoir on one end of the pan with a discharge spout and a container connected by a coupling to the spout. After collecting the used oil in the catch pan, the catch pan is tilted, causing the used oil to flow to the reservoir and drain through the spout into the container for containment and transport to a suitable location.

U.S. Pat. No. 4,625,780 discloses a vortex connector for threaded plastic bottles, provided in which the connector has a pair of opposed recesses, each connecting with an inner female helically threaded recess, the recesses connecting to one another through an axially elongated constriction venturi. One of the bottles is partially filled with water. The so-coupled bottles are pivoted so that the water containing bottle is on top, the upper bottle is given a circular swirl or two and the water flows in a clearly discernible whirlpool or vortex from the upper bottle to the lower while the displaced air flows from the lower bottle to the upper through the thus formed vortex in an educational or entertaining display.

U.S. Pat. No. 4,217,941 discloses a ketchup rapping apparatus having a pair of L-form racks hinged to one another, each being adapted to hold a ketchup bottle in a stationary seated position, one of the racks being pivotable through 180 degrees from a back-to-back relationship with the other rack to carry its bottle to inverted vertical alignment with the other bottle. There is a resilient guide cup to be disposed between the mouth ends of the aligned bottles for avoiding glass to glass bottle contact and for guiding the bottle being inverted down into the aligned position with the other bottle. A latch for securing the pivoted rack in the inverted condition, and shock absorbing pads on the bottom of the non-inverted rack enabling the rapping of the latter in the inverted condition of the apparatus against a solid surface so as to jar free a clogged ketchup flow condition without damaging the apparatus or the bottles.

U.S. Pat. No. 4,105,142 discloses a device for dispensing fluid substances which includes a dispensing container for holding a metered amount of the fluid substance therein immediately prior to dispensing and which includes a primary opening in the top edge thereof which is adapted to be capped during filling of the dispensing container and which is adapted to be opened when it is desired that the metered amount of fluid substance should be dispensed from the container. The dispensing container also includes a secondary opening in the lower section thereof which may be substantially smaller than the primary opening. The device further includes a hollow adapter secured to the secondary opening of the dispensing chamber and adapted to be secured to the neck of a bottle or other source of the fluid substance to be dispensed. The hollow adapter includes a dispensing collar adapted to be secured to the secondary opening of the dispensing container, and a holder collar adapted to be secured to the neck of a bottle or holder of the fluid substance.

U.S. Pat. No. 3,963,063 discloses a viscous liquid transfer device for emptying partially filled bottles of ketchup, mustard, etc. in restaurants, to make a full bottle. The device comprises an upwardly and downwardly flared cylinder having attached to an inner wall surface, a vent tube which extends into the bottle to be emptied while inverted with its neck supported on the upwardly flared portion, while the downwardly flared portion rests on the neck of the bottle to be filled.

U.S. Pat. No. 3,620,267 discloses a device for transferring viscous fluids, such as catsup, from one bottle to another, wherein an expansion chamber is provided between the pouring spouts of the bottles to enhance the downward flow of catsup by relieving the central portions thereof to permit air displaced from the lower bottle to bubble up through the flowing catsup into the upper bottle.

U.S. Pat. No. 3,266,533 discloses a draining assembly including a support base and a coupling member. The drainage assembly has a centrally recessed portion for receiving the bottom portion of a container in seated frictional engagement and a coupling member designed for slip-fit frictional engagement with the threaded outlet portion of the container. A threaded outlet portion of another container is supported in inverted position thereon.

U.S. Pat. No. 3,261,381 discloses a coupling member for tubes.

U.S. Pat. No. 3,261,380 discloses a support stand for supporting and draining ketchup bottles mouth to mouth.

U.S. Pat. No. 3,156,272 discloses an invention which relates generally to bottle coupling devices, and more particularly, to coupling devices for draining ketchup bottles or the like.

U.S. Pat. No. 2,773,521 discloses an invention which relates to an improved coupling for squeeze bottles and has for one of its principal objects the provision of a simple, efficient and easily operated device for refilling a squeeze-type dispenser container of liquids by the customer for reuse.

U.S. Design Pat. No. 431,971 discloses an ornamental design for a water bottle magnetic coupler.

The above citation of prior details many problems prevalent when draining the contents of one container into another container and the many attempts to solve such problems.

### BRIEF SUMMARY

A container coupler is disclosed that can be adapted to mechanically engage and squeeze the necks of two containers such that one of the containers can receive contents from the other container. In some embodiments, the container coupler has a single semi-rigid “C” shaped member that has an arcuate inner surface to engage the neck of the first container and the neck of the second container. The C shaped coupler can have a gap or opening the length of the coupler that forms the C, and latch that spans the gap. When the latch is in the process of being latched, the latch can pull both sides of the opening together, reducing the gap or the opening thereby reducing the inner arcuate surface such that the coupler grips the necks of the containers. The latch can have an adjustable linkage such that when adjusted properly the coupler can create a significant amount of force on the necks of the containers. When appropriately adjusted and secured the containers are almost impossible to separate by and a considerable force is required to separate the containers.

The latch can include a lever, a linkage and a keeper. The linkage can be rotatably engaged with the lever and the linkage can engage the keeper. In some embodiments, the lever can have a mechanical advantage and a cam action as it pulls the gap together. The lever and the linkage can be placed on a first side of the gap and the keeper can be placed on a second side of the gap. Moving the lever away from second side of the gap, or the keeper, can pull the keeper via the linkage and the second side of the gap can be pulled towards the first side of the gap, thereby reducing the inner diameter of the member. Thus, fastening the latch can reduce the inner diameter of the coupler thereby placing a radial force (a force towards the center of the mouth of the bottle) on the neck of the bottle. It can be appreciated that fastening the latch reduces the inner diameter of the container coupler and when adjusted appropriately can provide a significant radial force as the coupler is tighten around the neck of each container.

As stated above, in some embodiments, the C shaped coupler can be manufactured from a semi-rigid material and the gap can be one quarter of an inch when the latch is not placing a radial force on the neck of the containers. In other embodiments the coupler can be embodied as two C shaped members that are semi-circular and the two C shaped members can be pivotably attached to form a larger C shaped member that closely resembles an entire circle with a gap for reducing the inner diameter.

Thus, the two semicircular members can be connected in a first location with a hinge and can be connected together in a second location with the latch such that the gap between the “C” shaped pieces can be reduced as the coupler is tightened on the necks of the bottle with the latch. To accommodate containers with different neck sizes, inserts can be placed in the coupler to reduce the inner diameter to accommodate these bottles with different sized necks or mouths.

### BRIEF DESCRIPTION OF THE SEVERAL VIEWS OF THE DRAWING

FIG. 1 is an illustration of a two containers and a mouth coupler to couple the mouths of the two containers;

FIG. 2 is an illustration of a coupler for coupling a container to be drained of material to a container that is to receive the material;

FIG. 3 is an illustration of a coupler for coupling a container to be drained of material to a container that is to receive the material, where one of the containers has a smaller neck that the other container; and

FIG. 4 is a flow diagram of a method for draining the contents of one container to another container.

### DETAILED DESCRIPTION

The following is a detailed description of novel embodiments depicted in the accompanying drawings. The embodiments are in such detail as to clearly communicate the subject matter. However, the amount of detail offered is not intended to limit anticipated variations of the described embodiments; but on the contrary, the claims and detailed description are to cover all modifications, equivalents, and alternatives falling within the spirit and scope of the present teachings as defined by the appended claims. The detailed descriptions below are designed to make such embodiments understandable to a person having ordinary skill in the art. While specific embodiments will be described below with reference to adapters, components, circuits or logic configurations, those of skill in the art will realize that embodiments of the present disclosure may advantageously be implemented with other components and configurations.

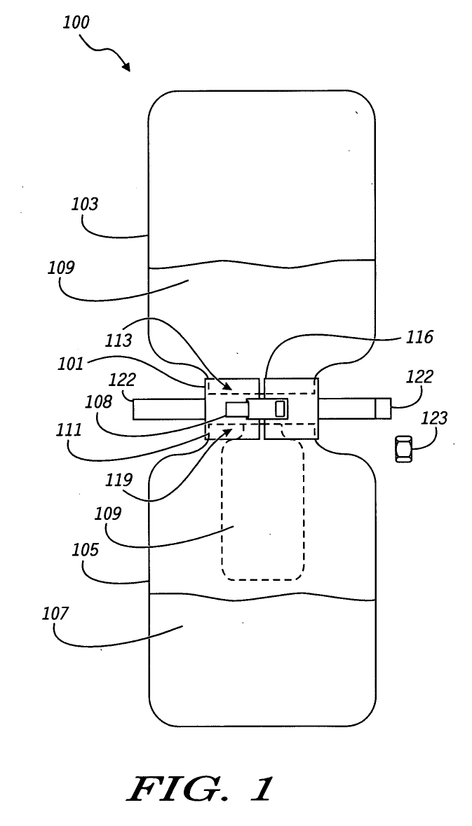

Referring to FIG. 1, a reservoir or container coupling system 100 is disclosed. The system 100 can include a first container 103, a second container 105 and a coupler 101 to couple or affix the first container 103 to the second container 105. The no leak, non-messy, user friendly, ergonomically pleasing coupling system 100 can allow the contents 109 of first container 103 to be drained out of the first container 103 and into the second container 105 possibly adding material to existing contents 107 of the second container 105. The coupler can have a latch 108 to secure the coupler 101 to the first container 103 and the second container 105.

The coupler 101 can have a C shape and can be made with a single or homogenous semi-rigid member that is made of plastic or metal. Gap 116 can define the C shape as the gap 1 16 can be larger when the latch 108 is not fastened and the size of the gap 116 can be reduced when the latch 108 is fastened. The gap 116 can be reduced in size as the latch 108 is utilized to pull opening in the C shaped member together.

The latch 108 can included a lever, a linkage and a keeper. The linkage can be rotatably engaged with the lever and the linkage can engage the keeper. In some embodiments, the lever can have a mechanical advantage and a cam action as it pulls on the material on each side of the gap 116 together. The lever and the linkage can be placed on a first side of the gap 116 and the keeper can be placed on a second side of the gap 116. Moving the lever away from second side of the gap or the keeper can pull the keeper via the linkage, and the second side of the gap can be pulled towards the first side of the gap 116, reducing the inner diameter of the coupler 101.

Accordingly, fastening the latch 108 can reduce the inner diameter of the coupler 101 thereby placing a radial force (a force towards the center of the mouth of the containers) on the neck of the containers 103 and 105. The latch can be adjustable with different keeper positions or a threaded linkage that can provide an adjustable inner diameter of the coupler 101 when the latch 108 is fastener. It can be appreciated that fastening the latch 101 reduces the inner diameter of the container coupler 101 and when adjusted appropriately, can provide a significant radial force as the coupler is tightened around the neck of each container 103 and 105.

As the inner diameter of the coupler 101 or the inner circumference of the coupler 101 is reduced, the coupler 101 can tightly secure containers 103 and 105 together, where the mouths of the containers 103 and 105 allow a viscous liquid or a liquid with suspended solids to be communicated between the containers 103 and 105. As is illustrated gravity can pull the contents of container 103 down and move the contents 109 of container 103 to container 105.

The coupler 101 can have handles 122 to make it easy to grasp the coupler 101 when placing the coupler 101 over the mouth, or neck 113 of container 103, or inserting the neck 113 of container 103 into the coupler 101. In addition, the handles 122 can make it easier to insert the neck 111 of container 105 into the coupler 101. Yet further the handles 122 can assist a user in removing the coupler 101 from the containers 103 and 105 after the material has been transferred from one container to the other container (i.e. from container 103 to container 105). In some embodiments, one or both of the handles 122 can act as the lever portion of the latch 108. The longer the lever the more radial force that can be applied to the necks 111 and 113. The handles 122 could also be utilized to kept the system 100 upright by resting the handles on one or more fixed surfaces such as surface 123

The coupler 101 can have frictional members in the inner arcuate surface and the frictional members in addition to the large radial force can secure the containers together such that if the containers 103 and 105 are knocked over the coupler 101 will keep the containers 103 and 105 together and no spillage will occur.

In some embodiments, a reducer insert 119, (shown in phantom by a dashed line), can be placed in the coupler 101. Coupler 101 can be utilized to couple container 103 to a smaller container 109, (also shown in phantom by a dashed line). In this embodiment, container 105 typically would not be present. It can be appreciated that the contents of container 103 can be a very viscous material and the disclosed coupler 101 allows such a viscous material to be drained into the second container 105 or 109 over a period of time without labor or supervision and no spills will occur if the containers fall off of a countertop onto the floor. The disclosed system 100 can be utilized in the restaurant industry to complete the emptying of large gallon containers.

In addition, the system 100 can also be utilized to fill smaller squeeze type containers from a larger gallon container. For example, many sandwich shops utilize a squeeze bottle of a size that is easy to handle and squeeze while making sandwiches. Flavouring products or sauces such as catsup, mustard, mayonnaise, dressings, etc., are often purchased cheaper in a gallon container (such as container 103) but applied to a sandwich with a squeeze bottle (such as bottle 109). Thus, such squeeze bottles often need to be refilled from a larger container such as from a gallon container.

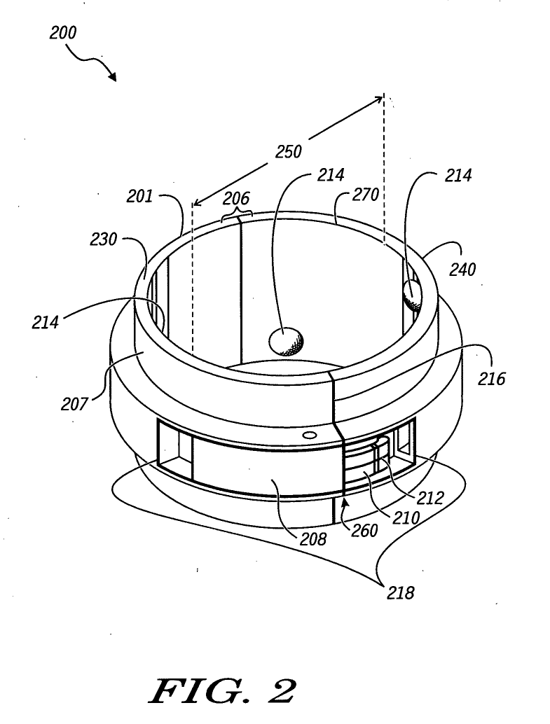

Referring to FIG.2, a more detailed view of coupler 201 (101 in FIG. 1) is depicted. The coupler 201 can include a first member 230, a second member 240, a hinge 206, neck grippers 214 and a latch 208 illustrated in an area defined by a dashed line. The latch 208 can include a latch lever 208, a linkage 210 and a keeper or linkage receiver 212. A gap can be placed in the system 200 such that at least one inner dimension of the coupler 201 can be reduced to engage the containers.

In one embodiment, a first member 230 can be rotatably affixed to a second member 240 via a hinge 206. In another embodiment, the coupler 201 can be made as a single member that is semi-rigid and this embodiment there is no need for the hinge 206. In this embodiment, the coupler 201 could be made from a material that can flex to close the gap 216 as the latch 208 is secured. Thus, a secured latch 208 can reduce an inner dimension 250 to secure the coupler 201 to the neck of two containers. It can be appreciated that the coupler 201 can be manufactured from a material that is easy to clean and disinfect and can be configured such that is smooth and does not have a lot of crevices making it easy to clean and disinfect. The coupler 201 can be made from materials that include polyvinyl chloride (PVC), acrylonitrile butadiene styrene (ABS), or some other polymer. In addition the coupler 201 can be manufactured from a metal such as aluminum or stainless steel.

In the single member embodiment, the semi-rigid member can have an arcuate inner surface to engage a neck of a first container and a neck of a second container. The latch 208 can be a matched set of a latch lever 208 and a latch linkage 210 to connect the lever 208 with the linkage receiver 212. In operation, a neck of a first container can be placed in the container coupler 201 and a neck of a second container can be placed in the container coupler 201 and the latch in a cam action can pull the sides of the member together reducing the size of the gap 216 forcing container neck grippers 216 into threads on the containers such that the containers are tightly secured together. Generally, closing the gap 216 places a radial force on the neck, compressing, constricting, squeezing, narrowing and possibly slightly deforming the neck.

To engage the containers, a user can place the necks in the coupler 201 and can place the linkage 210 over the link receiver 212, (which can be shaped as a single hook or multiple hooks and the user can move the lever away from the keeper 212 such that the size of the gap 216 is reduced. As the size of the gap 216 is reduced, the mouths or necks of the two containers can be secured together and the fluid can be transferred from container to container. Generally, engaging the linkage 210 with the linkage receiver 212 and pulling the lever 208, or fastening the latch 218, can reduce a dimension 250 of the coupler 201 (also the inside circumference or inside radius of the coupler 201) thereby tightening the engagement of the coupler 201 to a neck of the first container and the second container.

It can be appreciated that a significant amount of leverage can be provided by the lever 208 and a cam or cam action if the latch 218 is an over center latch, then the lever can snap into position when activated. In other embodiments, the lever can be secured to the coupler body when activated. When the latch is secured, the coupler 201 can be tightly engaged with the necks of the containers. In some embodiments, the linkage 210 can be a wire that is placed in a recess in the linkage receiver 212. In some embodiments, the linkage 210 can be a threaded hook that can have a length from the lever 208 that can be adjusted. This adjustment can determine the inner diameter of the coupler when the latch is engaged and when the latch is not engaged.

When the two member embodiment is implemented with first member 230, second member 240 and pivot point or hinge 206, the hinge can have a pin that can be removed for cleaning purposes. The first member 230, can be pivotably engaged with second member 240 and removing the pin can create two separate parts that are easier to clean and sanitize separately.

Many types of latches 218 can be utilized to secure the coupler 201 to the containers. For example, the latch could be an over center latch, an under center latch, a draw latch, a soft latch, lever assisted latch, a wire link latch an adjustable draw latch to name a few. In some embodiments the coupler 201 can be adapted to secure gallon containers where the neck of the container has in outside diameter of greater than three and seven eighths inches. The lever can be selectively maintained in a fixed position relative to the coupler such that when the lever is moved to a corresponding position to move the link member traverse to the receiver 212 to allow the first and second members to pivot relative to each other to secure the container necks. The lever can maintain a locked position until the lever is moved from the position to a second position.

The first member 230, can have an arcuate inner surface to engage a first portion of a neck of a first container and to engage a first portion of a neck of a second container. In addition, the second member 240 can have an arcuate inner surface to engage a second portion of the neck of the first bottle and a second portion of a second bottle. The second member 240 can be pivotable in relation to the first member 230 via hinge 206.

The latch lever 208 can be pivotably attached to the first member 230 to engage the latch keeper 212 to pull the first member 230 towards the second member 240 to engage a neck of a first bottle and a neck of a second bottle. The hinge 206 can connect the first member 230 to the second member 240. The latch 218 can include a cam 260, a lever 208, a link 210 pivotably attached to the lever 208, and a link 210 to engage the keeper 212 where the link 210 can pull the first member 230 to the second member 240 as the lever 208 is activated or pulled close to the first member 230.

In addition, a locking member such as neck engagers 214 can be adapted to engage and lock into a groove of the container neck to securely hold the container necks in place within the coupler 210. In some embodiments, the sealing member 270 can be a softer polymer such as a rubber material that can provide a seal between the coupler and the container.

Thus, the sealing member 270 can be adapted to seal the coupler 201 to the container near the neck of the container. The sealing member 270 can be biased such that the sealing member 270 is urged against the container when the container is received within the coupler 201.

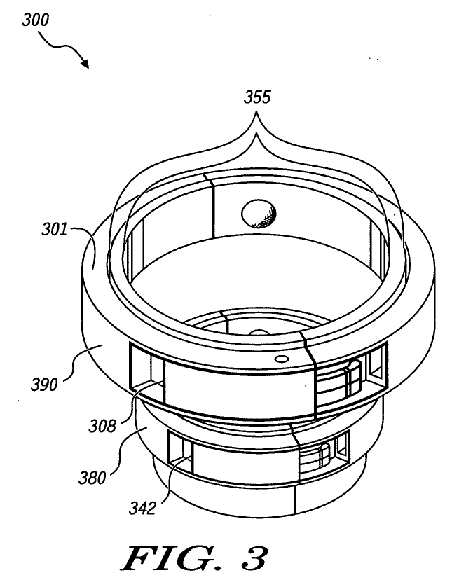

Referring to FIG.3, a coupler 301 of a container drainage system 300 is illustrated. The embodiment of FIG.3 illustrates a coupler 301 that could be utilized to couple a gallon container to a smaller container such as a squeeze bottle. The coupler 301 could include a first latch 308 and a second latch 342.

The coupler 301 could have a top member 390 and a bottom member 380 connected by an interface that allows the top member 390 to reduce in dimension more than the bottom member 380. The coupler 301 can have a seal cutter 355 to cut a seal on the first container as the first container is placed onto the coupler 301. Thus, when a new one gallon container is being utilized to fill a smaller squeeze bottle, the seal need not be broken prior to placing the container into the coupler 301.

On the larger opening, the coupler 310 can have an inner diameter of slightly over four and one quarter inches and the reduced first dimension when the latch is secured can be four and one eighth inches in diameter. The smaller side of the coupler or adapter can have an inner diameter of two and three quarter inches or two inches. The keepers can protrude internally one eighth of an inch.

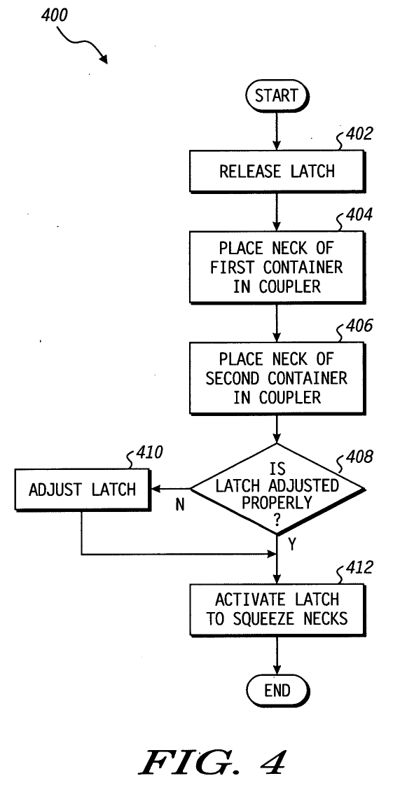

Referring to FIG. 4, a flow diagram for using a coupler is illustrated. As illustrated by block 402, the latch can be released to make the inner diameter large enough to allow for the insertion of necks of containers. As illustrated by block 404, the neck of a first container can be placed in the coupler. As illustrated by block 406, the neck of a second container can be place in the coupler. As illustrated by decision block 408 it can be determined if the latch is adjusted properly. If the latch is not adjusted properly the latch can be adjusted as illustrated by block 410. The latch can be activated and the coupler can place a radial force on the necks of the bottles squeezing the necks creating a robust mouth to mouth connection for the bottles.

This disclosure has been presented for purposes of illustration and description but is not intended to be exhaustive or limiting. Many modifications and variations will be apparent to those of ordinary skill in the art. The embodiments were chosen and described in order to explain principles and practical application, and to enable others of ordinary skill in the art to understand the disclosure for various embodiments with various modifications as are suited to the particular use contemplated.

1. An apparatus comprising:
a member having an arcuate inner surface to engage a neck of a first container and a neck of a second container, the arcuate inner surface having a first dimension;
a latch connected to the member; and
a keeper connected to the member and configured to engage the latch, wherein engaging the latch with the keeper and fastening the latch reduces the first dimension to tighten the engagement of the neck of the first container and the engagement of the neck of the second container.

2. The apparatus of claim 1 wherein the member comprises a first member and a second member where the first member is pivotably engagable with the second member.

3. The apparatus of claim 1 wherein the latch is connected to the first member and the keeper is attached to the second member.

4. The apparatus of claim 1 wherein the latch is one of an over center latch, an under center latch a draw latch, or a soft latch.

5. The apparatus of claim 1 wherein the latch is a lever assisted latch.

6. The apparatus of claim 1 wherein the latch is a wire link latch.

7. The apparatus of claim 1 wherein the latch is an adjustable draw latch.

8. The apparatus of claim 1 wherein the reduced first dimension is four and one eight inches.

9. A system comprising:
a first member having an arcuate inner surface to engage a first portion of a neck of a first container and a second container;
a second member having an arcuate inner surface to engage a second portion of a neck of the first container and the second container, the second member pivotable in relation to the first member;
a latch keeper attached to the first member; and
a latch pivotably attached to the second member to engage the latch keeper and to pull the first member towards the second member to reduce a dimension between the first member and the second member to secure the first container to the second container.

10. The system of claim 9 further comprising a hinge connecting the first member to the second member.

11. The system of claim 9 wherein the latch comprises a cam and a lever.

12. The system of claim 9 further comprising a link pivotably attached to the lever, the link to engage the keeper and the link to pull the first member to the second member if the lever is activated.

13. The system of claim 9 further comprising a locking member that is adapted to engage a locking groove of the container so as to securely hold the container in place within the coupler

14. The system of claim 9 further comprising a sealing member that is adapted to seal about the first and second container, the sealing member being biased so as to be urged against the first and second container when it is received within the coupler.

15. The system of claim 9 further comprising a mechanism to selectively maintaining the first member in a fixed position relative to a second member.

16. The system of claim 9 when the handle is moved to a corresponding second handle position to move the link member traverse to the second member to allow the first and second members to pivot relative to each other, wherein the link member maintains the first and second members in the locked position until the handle is moved from the first handle position to the second handle position.

17. The system of claim 9 further comprising a mechanism to cut a seal on the first container as the first container is engaged with the coupler.

18. The system of claim 9 further comprising an insert to reduce an inner diameter of the coupler to accommodate a smeller neck of a container.

19. A method comprising:
releasing a latch on a container coupler, the container coupler having an inner diameter;
placing a neck of a first container in the container coupler;
placing the neck of a second container in the container coupler; and
activating a latch to reduce the inner diameter thereby placing a radial force on the neck of the first container and the neck of the second container.

20. The method of claim 19 further comprising adjusting a setting of the latch where the adjustment places more or less radial force on the neck of at least the first container.
